(19) United States
(12) Patent Application Publication
(10) Pub. No.: US 2021/0080208 A1
(43) Pub. Date: Mar. 18, 2021

(54) Firearm with User Identification System

(71) Applicant: NINGBO SUNNY OPOTECH CO., LTD., Ningbo (CN)

(72) Inventors: Xudong WU, Ningbo (CN); Zhongwei WANG, Ningbo (CN); Xinjiang WANG, Ningbo (CN)

(21) Appl. No.: 16/572,566

(22) Filed: Sep. 16, 2019

(51) Int. Cl. F41A 17/06; G06F 16/55; G08B 25/01

(52) U.S. Cl. CPC F41A 17/066; G08B 25/014; G06F 16/55; F41A 17/063

(57) ABSTRACT

A firearm system includes a firearm and a user identification system built-in with the firearm. The user identification system includes a locking module that releasably locks up a trigger-actuated firing mechanism of the firearm from being actuated, a camera module being activated for generating tangible evidence of operation incidents, and an activation module operatively linked to the locking module. The activation module pre-stores authorized user data and continuously collects user operation data not only to activate the camera module for capturing image but also to actuate the locking module to unlock the trigger-actuated firing mechanism when the authorized user data is matched with the user operation data. Once the authorized user data is not match with the user operation data, the trigger-actuated firing mechanism is instantaneously locked to prevent an unauthorized usage of the firearm.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to firearms, and more particular to a firearm with user identification system, which is able to identify the user for preventing unauthorized operation of the firearm and to collect the firearm data of the firearm during the operation.

### Description of Related Arts

According to the survey, 42% of Americans live in household with guns and 66% of American households report owning at least one gun. In particular, the average American gun owner owns three guns according to the survey in 2015. 80% of guns used in crimes are obtained legally and 18% of guns used in crimes are obtained illegally, wherein about 75% hand guns and 9% of rifles are used in crime. In other words, gun control in America is such a big problem and it is urgent to have a tighter restrictions and regulation for gun control.

There are many methods of safeguarding and protecting weapons from being fired accidentally, misused or by an unauthorized person. For example, the weapon comprises a locking mechanism that requires a physically unlocking actuation to unlock the weapon so as to prevent the weapon from being fired accidentally. Likewise, the locking mechanism may incorporate with biometric authentication, such as fingerprint, for identifying the user in order to reduce risk of misidentification. However, such locking mechanism can only lock up the actuation of the weapon. Once the weapon is unlocked, an unauthorized person may operate the unlocked weapon intentionally.

The weapon may further incorporate with a safeguarding device to ensure the proper operation of the weapon. For example, the safeguarding device comprises a video camera module detachably mounted to the weapon to record the shooting operation of the weapon. Since the video camera module is an additional accessory for the weapon, the video camera module can be easily detached from the weapon. In other words, the user, including the authorized user and unauthorized person, can simply remove the video camera module from the weapon before and after the operation thereof. In addition, all different components, such as the locking mechanism and the video camera module, are working individually, so that the user must activate and/or operate each component individually.

### SUMMARY OF THE PRESENT INVENTION

The invention is advantageous in that it provides a firearm with a user identification system, which is able to identify the user for preventing unauthorized operation of the firearm and to collect the firearm data of the firearm during the operation.

Another advantage of the invention is to provide a firearm with a user identification system, which comprises a camera module being activated for generating tangible evidence of operation incidents.

Another advantage of the invention is to provide a firearm with a user identification system, wherein the camera module and the locking module are actuated and are activated at the same time by the activation module in order to operate the firearm.

Another advantage of the invention is to provide a firearm with a user identification system, wherein the activation module is automatically activated via a touch sensor, an environmental sensor, and/or a gyro sensor.

Another advantage of the invention is to provide a firearm with a user identification system, wherein the shooting image of the firearm and the facial image of the user are captured at the same time to generate the tangible evidence of operation incidents.

Another advantage of the invention is to provide a firearm with a user identification system, wherein a voice recorder is built-in with the camera module and is activated at the same time for sound recording.

Another advantage of the invention is to provide a firearm with a user identification system, wherein a GPS module is built-in with the firearm to detect a location of the firearm.

Another advantage of the invention is to provide a firearm with a user identification system, wherein the firearm is wirelessly linked to a user identification server, such that once the user identification server receives the user operation data from the user identification system, the user identification server will send a feedback signal as an unlocking code back to the user identification system to actuate the locking module.

Another advantage of the invention is to provide a firearm with a user identification system, wherein two or more firearms with the user identification systems can be linked to the user identification server, so as to control the firearms at the same time.

Another advantage of the invention is to provide a firearm with a user identification system, wherein the user identification system is able to incorporate with different kinds of firearms such as handguns or rifles in order to prevent any unauthorized operation of the firearm.

Another advantage of the invention is to provide a firearm with a user identification system, wherein no expensive or complicated structure is required to employ in the present invention in order to achieve the above mentioned objects. Therefore, the present invention successfully provides an economic and efficient solution for providing an effective tool for preventing any unauthorized operation of the firearm.

Additional advantages and features of the invention will become apparent from the description which follows, and may be realized by means of the instrumentalities and combinations particular point out in the appended claims.

According to the present invention, the foregoing and other objects and advantages are attained by a firearm system, comprising a firearm which comprises a trigger-actuated firing mechanism, and a user identification system built-in with the firearm.

The user identification system comprises:

a locking module that releasably locks up the trigger-actuated firing mechanism from being actuated;

a camera module being activated for generating tangible evidence of operation incidents; and

an activation module operatively linked to the locking module, wherein the activation module pre-stores authorized user data and continuously collects user operation data not only to activate the camera module for capturing images but also to actuate the locking module to unlock the trigger-actuated firing mechanism when the authorized user data is matched with the user operation data.

In accordance with another aspect of the invention, the present invention comprises a method of preventing an unauthorized operation of a firearm, comprising the following steps.

(A) Via a locking module built-in with the firearm, normally lock up a trigger-actuated firing mechanism of the firearm from being actuated.

(B) When a user intends to operate the firearm, via an activation module built-in with the firearm, activate the locking module and a camera module for generating tangible evidence of operation incidents.

(C) Via the activation module, continuously collect user operation data of the firearm.

(D) Determine whether the user operation data is matched with a pre-stored authorized user data in order to unlock the trigger-actuated firing mechanism.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating a firearm with a user identification system according to a preferred embodiment of the present invention.

FIG. 2 is a perspective view of the firearm with the user identification system according to the preferred embodiment of the present invention.

FIG. 3 is a block diagram illustrating a configuration of the firearm system according to the preferred embodiment of the present invention.

FIG. 4 is a flow diagram illustrating a method of preventing an unauthorized operation of the firearm with the user identification system according to the preferred embodiment of the present invention.

FIG. 5 is a flow diagram illustrating the normal mode of the firearm system according to the preferred embodiment of the present invention.

FIG. 6 is a flow diagram illustrating the unauthorized mode of the firearm system according to the preferred embodiment of the present invention.

FIG. 7 is a flow diagram illustrating the automatic reporting mode of the firearm system according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

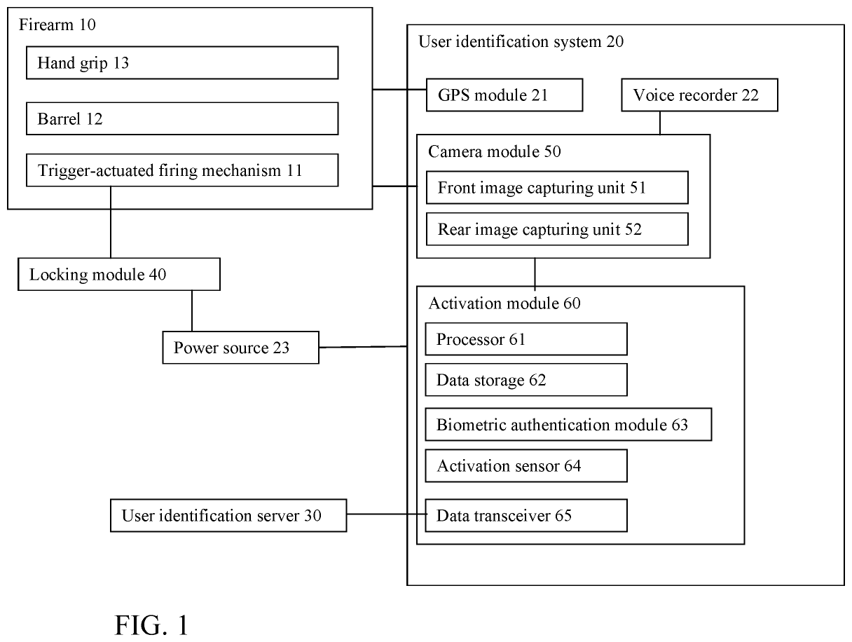

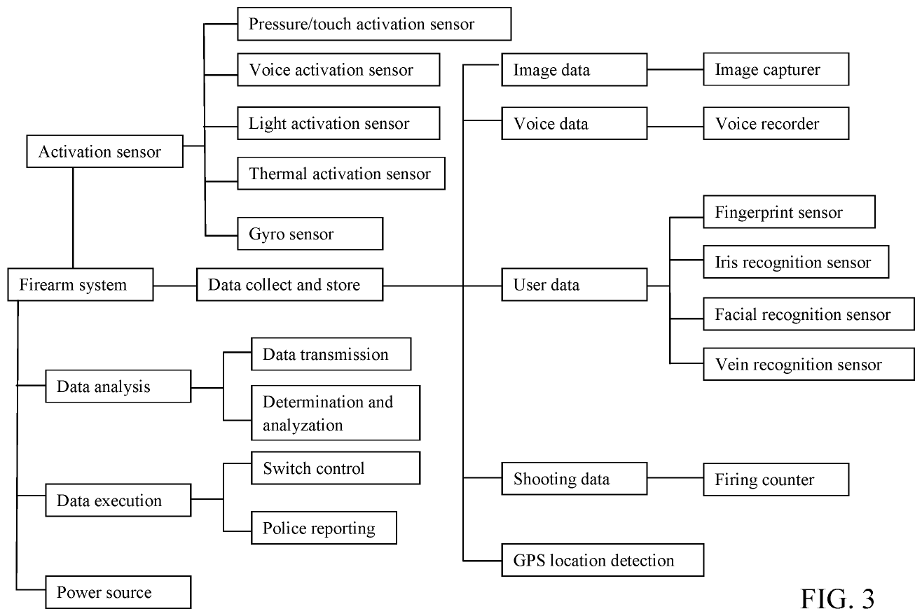

Referring to FIGS. 1 to 3 of the drawings, a firearm system according to a preferred embodiment of the present invention is illustrated, wherein the firearm system comprises a firearm 10, a user identification system 20 built-in with the firearm 10, and a user identification server 30 wirelessly communicating with the user identification system 20.

According to the preferred embodiment, the firearm 10 can be a hand gun, a rifle, or the like. Accordingly, the firearm 10 comprises a trigger-actuated firing mechanism 11, such as a triggering device, a barrel 12, and a hand grip 13.

The user identification system 20 is built-in with the firearm 10, wherein the user identification system 20 comprises a locking module 40, a camera module 50, and an activation module 60.

According to the preferred embodiment, the locking module 40 is built-in with the firearm 10 to releasably lock up the trigger-actuated firing mechanism 11 from being actuated. In one embodiment, the triggering device of the firearm 10 is locked to prevent the actuation of the firearm 10 via a finger of the user. Alternatively, a hammer of the firearm 10 can be locked to prevent the striking action of the firearm 10. It is worth mentioning that the locking module 40 is actuated to lock up the trigger-actuated firing mechanism 11 after each shooting operation of the firearm 10. In other words, the user must re-actuate the locking module 40 to unlock the trigger-actuated firing mechanism 11 after every single firing action. Once the triggering device of the firearm 10 is actuated to complete one shooting operation of the firearm 10, the locking module 40 will automatically lock the trigger-actuated firing mechanism 11, so as to prevent an intruder from pillaging the firearm 10 or to reduce the misuse of the firearm 10.

The camera module 50 is built-in with the firearm 10 and is activated for generating tangible evidence of operation incidents. Preferably, the camera module 50 is provided at a top side of the firearm 10 for image capturing.

The activation module 60 is operatively linked to the locking module 40 and the camera module 50, wherein the activation module 60 pre-stores authorized user data and continuously collects user operation data not only to activate the camera module 50 for capturing image but also to actuate the locking module 40 to unlock the trigger-actuated firing mechanism 11 when the authorized user data is matched with the user operation data.

In one embodiment, the activation module 60 comprises a processor 61 and a data storage 62 operatively linked to the processor 61, wherein the authorized user data is pre-set or pre-stored in the data storage 62. Accordingly, the authorized user data contains biometric information of the user, i.e. the authorized user or the owner of the firearm 10. The activation module 60 further comprises a biometric authentication module 63 built-in with the firearm 10 to unlock the trigger-actuated firing mechanism 11 in response to the biometric information of the user. Particularly, the biometric authentication module 63 is operatively lined to the processor 61 and the data storage 62, such that the biometric information of the user can be delivered to the biometric authentication module 63 and the data storage 62. Preferably, the biometric authentication module 63 comprises a biometric sensor such as a fingerprint sensor, an iris recognition sensor, a facial recognition sensor, and/or a vein recognition sensor (finger vein recognition sensor). For example, the fingerprint sensor and/or the vein recognition sensor can be built-in with the hand grip 13 of the firearm 10 to detect the fingerprint and/or a pattern of vein corresponding to the gripping position of the firearm 10 by the user's hand. The iris recognition sensor and/or a facial recognition sensor can be built-in with the camera module 50. Accordingly, when the biometric authentication module 63 detects the biometric information of the user, the processor 61 will match the biometric information of the user with the authorized user data. If the biometric information of the user matches with the authorized user data, the locking module 40 will be actuated to unlock the trigger-actuated firing mechanism 11.

The activation module 60 is automatically self-activated to actuate the locking module 40 and to activate the camera module 50 at the same time. In one embodiment, the activation module 60 further comprises an activation sensor 64 operatively linked to the processor 61 to self-activate the activation module 60. The activation sensor 64 can be a pressure activation sensor/touch activation sensor provided at the hand grip 13 of the firearm 10 to actuate the locking module 40 and to activate the camera module 50 at the same time when the hand grip 13 of the firearm 10 is touched. The activation sensor 64 can be an environmental activation sensor provided at the firearm 10 to actuate the locking module 40 and to activate the camera module 50 at the same time. The environmental activation sensor can be a light activation sensor and/or a thermal activation sensor provided at the firearm 10. The activation module 60 is automatically self-activated when light is detected by the light activation sensor, such as taking the firearm 10 out of a save box. The activation module 60 is automatically self-activated when heat is detached by thermal activation sensor, such as gripping at the hand grip 13 of the firearm 10 or heated at the barrel 12 of the firearm 10. The activation sensor 64 can be a voice activation sensor provided at the firearm 10 to actuate the locking module 40 and to activate the camera module 50 at the same time by the voice of the user. The activation sensor 64 can be a gyro sensor built-in with the firearm 10 to actuate the locking module 40 and to activate the camera module 50 at the same time when a movement of the firearm is detected by the gyro sensor. In other words, the user does not require any manual action to activate the activation module 60 that the activation module 60 is automatically self-activated to actuate the locking module 40 and to activate the camera module 50 at the same time.

According to the preferred embodiment, the camera module 50 comprises a front image capturing unit 51 provided at the firearm 10 for capturing a shooting image of the firearm 10 and a rear image capturing unit 52 provided at the firearm 10 for capturing a facial image of the user, wherein the shooting image and the facial image are stored in the data storage 62. The front image capturing unit 51 has a shooting direction aligning with a shooting direction, i.e. the axis of barrel 12 to precisely capture the shooting image of the firearm 10. The rear image capturing unit 52 is preferably provided on the top side of the firearm 10 to capture the facial image of the user. In one embodiment, the front and rear image capturing units 51, 52 can be dual-sided camera provided at an aiming device of the firearm 10. It is worth mentioning that the facial recognition sensor of the biometric authentication module 63 can be incorporate with the rear image capturing unit 52. Preferably, at least one of the front image capturing unit 51 and the rear image capturing unit 52 comprises a dual camera module which comprises an infrared camera and a camera. The infrared camera can capture images, i.e. the shooting image and/or the facial image, under the dark environment.

Accordingly, the user identification system 20 further comprises a GPS module 21 built-in with the firearm 10 to detect a location of the firearm 10, and a voice recorder 22 configured to incorporate at least one of the front image capturing unit 51 and the rear image capturing unit 52. The voice recorder 22 is activated at the same time with at least one of the front image capturing unit 51 and the rear image capturing unit 52 for sound recording. Preferably, the voice recorder 22 is built-in with the rear image capturing unit 52 for recording the sound from the user. Therefore, the camera module 50 with the voice recorder 22 is intended for civilians, law enforcement, and military professionals to generate tangible evidence for examination of the firearm shooting related incidents.

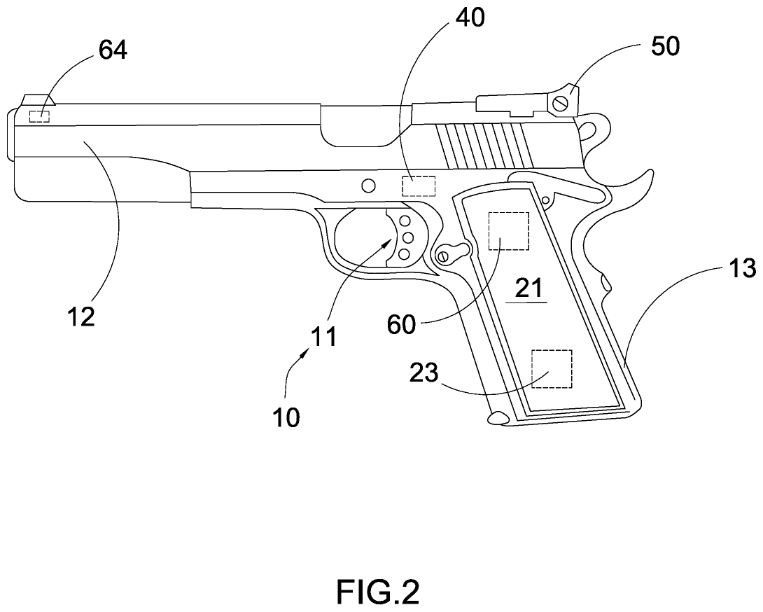

The user identification system 20 further comprises a power source 23 provided at the firearm 10 for as a single power supply for the locking module 40, the camera module 50, the activation module 60, and the GPS module 21. As shown in FIG. 2, the power source 23 comprises a battery compartment provided at one side of the hand grip 13 of the firearm 10 for receiving at least one of rechargeable battery and disposable battery. Preferably, the power source 23 is a rechargeable battery built-in at the hand grip 13 of the firearm 10 and a charger terminal, such as USB terminal, to charge the rechargeable battery.

Since the power source 23 is formed as a single power supply to electrically connect with all of the locking module 40, the camera module 50, the activation module 60, and the GPS module 21, the user does not require checking the power status of each component. In addition, the activations among the locking module 40, the camera module 50, the activation module 60, and the GPS module 21 can be synchronized via the power source 23 as a closed circuit of the user identification system 20.

According to the preferred embodiment, the user operation data contains locking/unlocking data from the locking module 40, activation data from the activation module 60, such as the activation time of the firearm 10, the shooting image of the firearm 10 via the front image capturing unit 51, the facial image of the user via the rear image capturing unit 52, the recorded sound from the voice recorder 22, and/or the location of the firearm 10 via the GPS module 21. For example, when the user grips the hand grip 13 of the firearm 10, the touch activation sensor is activated to generate the activation data as one of the user operation data. Likewise, when the user grips the hand grip 13 of the firearm 10, the trigger-actuated firing mechanism 11 is unlocked by the locking module 40 that the unlocking data is generated as one of the user operation data.

According to the preferred embodiment, the user identification server 30 is wirelessly linked with the user identification system 20 via Internet or other wireless communication network. In one embodiment, the authorized user data is pre-stored in the user identification server 30. The activation module 60 further comprises a data transceiver 65 built-in with the firearm 10 to wirelessly and continuously send out the user operation data to the user identification server 30. Preferably, the data transceiver 65 is built-in at the hand grip 13 of the firearm 10 and is electrically connected to the power source 23. Accordingly, as the activation module 60 continuously collects user operation data, the data transceiver 65 continuously sends out the user operation data to the user identification server 30.

The user identification server 30 is configured for data analysis and storage. Accordingly, the user identification server 30 will store image data from the camera module 50, voice data from the voice recorder 22, user data from the fingerprint sensor, iris recognition sensor, facial recognition sensor, and/or vein recognition sensor, shooting data from a firing counter, and GPS location data from the GPS module 21. It is worth mentioning that the firing counter, such as a bullet counter, can be incorporated with the thermal activation sensor or can be an individual component built-in with the firearm 10 to count the number of bullet usage.

In addition, the user identification server 30 will analyze data, i.e. the user operation data, from the activation module 60. Accordingly, the user identification server 30 sends out an unlocking code to the data transceiver 65 to actuate the locking module 40 so as to unlock the trigger-actuated firing mechanism 11 when the user operation data is matched with the authorized user data. It is worth mentioning that the user identification server 30 is incorporated with a switch control that once the user operation data is mismatched with the authorized user data, the switch control is activated to send out the locking code to the data transceiver 65 so as to instantaneously lock the trigger-actuated firing mechanism 11 of the firearm 10. The user identification server 30 will automatically report the user operation data to the closest police station according to the firearm location from the GPS module 21.

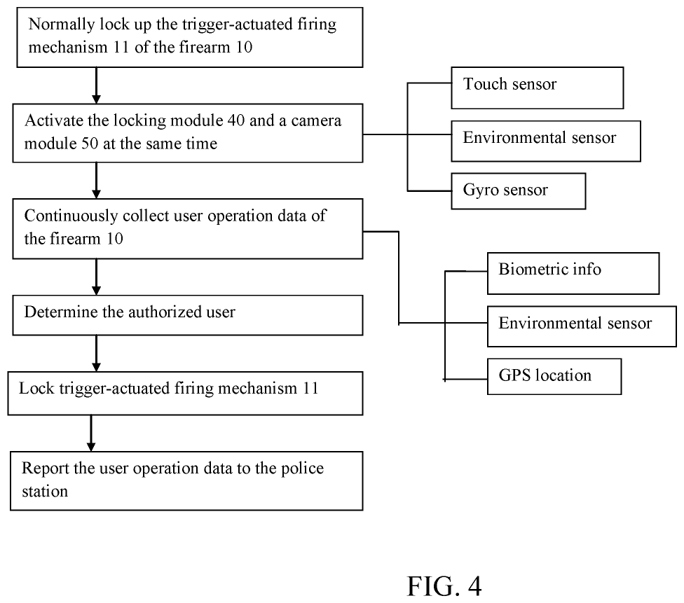

FIG. 4 illustrates a method of preventing an unauthorized operation of the firearm 10 which comprises the following steps.

(1) Via the locking module 40 built-in with the firearm 10, normally lock up the trigger-actuated firing mechanism 11 of the firearm 10 from being actuated.

(2) When the user intends to operate the firearm 10, via the activation module 60 built-in with the firearm 10, activate the locking module 40 and a camera module 50 for generating tangible evidence of operation incidents. Accordingly, the activation module 60 can be activated by the touch sensor, environmental sensor, and/or gyro sensor.

(3) Via the activation module 60, continuously collect user operation data of the firearm 10. Accordingly, the user operation data can be collected from the environmental sensor, a biometric information of the user from the biometric authentication module 63, and/or the location of the firearm 10 via the GPS module 21.

(4) Determine whether the user operation data is matched with the pre-stored authorized user data in order to unlock the trigger-actuated firing mechanism 11.

(5) Instantaneously lock the trigger-actuated firing mechanism 11 of the firearm 10. The trigger-actuated firing mechanism 11 is automatically locked in different situations when the user identification server 30 analyzes the data. For normal firearm owners, civilians, and potential criminals, the trigger-actuated firing mechanism 11 is automatically locked when the user operation data is mismatched with the authorized user data. The trigger-actuated firing mechanism 11 is automatically locked when a bullet shooting number of the firearm 10 reaches a predetermined bullet shooting threshold. For example, the bullet shooting threshold can be set as five, such that when the user fires the firearm 10 five time, the firearm 10 will be automatically locked for preventing mass shooting incident. The trigger-actuated firing mechanism 11 is automatically locked when the user image captured by the camera module 50 is matched with criminal data in a criminal record database. The criminal record database is stored in the user identification server 30 and is updated frequently from the police report or other government departments. Once the user facial image is captured by the rear image capturing unit 52 and is sent to the user identification server 30, the user identification server 30 will match the user facial image with the criminal data in the criminal record database, so as to prevent the intruder from pillaging the firearm 10.

(6) Automatically report the user operation data to the police station. In particular, for law enforcements and military professionals, the actuation of the firearm 10 will be automatically reported to the police station to inform police support and to provide tangible evidence for examination of the firearm shooting related incidents.

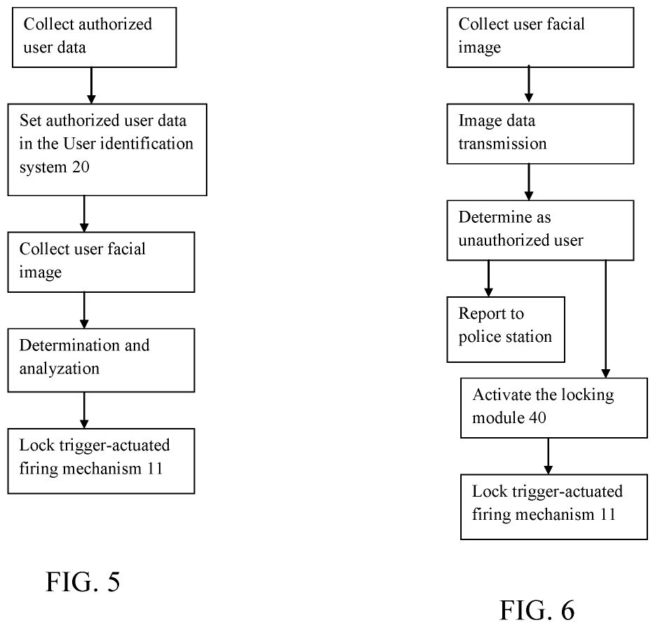

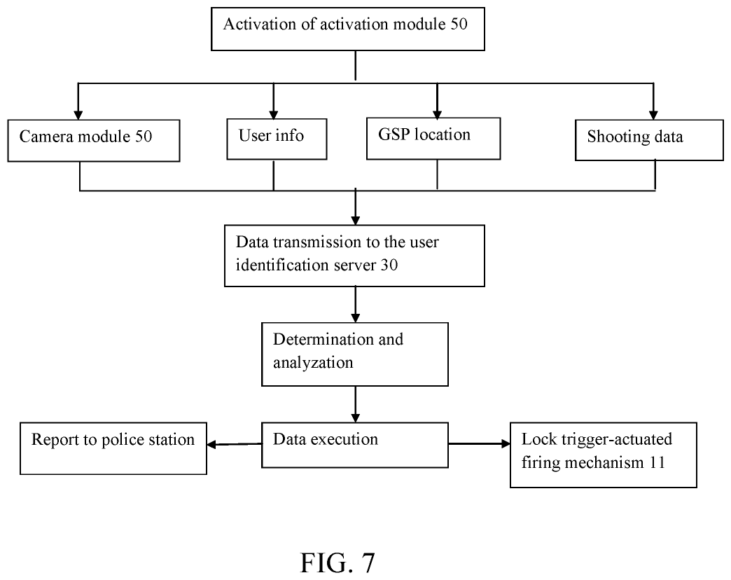

It is worth mentioning that the firearm system of the present invention can be pre-configured and automatically switched in different modes. The first mode, as shown in FIG. 5, is a normal mode for the firearm owners and civilians, wherein the authorized user data is collected and pre-set in the user identification system 20. When the activation module 60 is activated, the user facial image will be saved and stored in the user identification system 20 for determination and analysis. The trigger-actuated firing mechanism 11 is automatically locked once the user operation data is mismatched with the authorized user data. The second mode, as shown in FIG. 6, is an unauthorized mode that the firearm 10 is being by an unauthorized person and/or an unauthorized location. In case the firearm is stolen or taken by other people as the unauthorized person, the facial image of the unauthorized person will be analyzed, which is not match with the facial image of the designated user. Therefore, the trigger-actuated firing mechanism 11 is automatically locked and the facial image of the unauthorized person will send to the police station. Furthermore, the location of the firearm 10 can be pre-set in a designated location range, such as home or office. Once the GPS module 21 detects the firearm 10 being out of the location range, the trigger-actuated firing mechanism 11 is automatically locked even though the user is the authorized user. The third mode, as shown in FIG. 7, is an automatic reporting mode that once the firearm 10 is operated, i.e. shooting operation, the user identification system 20 will report to the police station instantly. Accordingly, the user operation data, including locking/unlocking data from the locking module 40, activation data from the activation module 60, such as the activation time of the firearm 10, the shooting image of the firearm 10 via the front image capturing unit 51, the facial image of the user via the rear image capturing unit 52, the recorded sound from the voice recorder 22, the location of the firearm 10 via the GPS module 21 and/or the shooting data, will be sent to the police station.

For further data analysis, the trigger-actuated firing mechanism 11 is automatically locked when the shooting image from the front image capturing unit 51 is aimed at the head of the potential victim, i.e. the firearm 10 is aimed thereat. Likewise, the trigger-actuated firing mechanism 11 is automatically locked when the shooting image from the front image capturing unit 51 is analyzed as an underage person by analyzing the facial image of the potential victim.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A firearm system, comprising:
a firearm which comprises a trigger-actuated firing mechanism; and
a user identification system built-in with said firearm, which comprises:
a locking module that releasably locks up said trigger-actuated firing mechanism from being actuated;
a camera module being activated for generating tangible evidence of operation incidents; and
an activation module operatively linked to said locking module and said camera module, wherein said activation module pre-stores authorized user data and continuously collects user operation data not only to activate said camera module for capturing image but also to actuate said locking module to unlock said trigger-actuated firing mechanism when said user operation data is matched with said authorized user data.

2. The firearm system, as recited in claim 1, wherein said activation module comprises a touch activation sensor provided at a hand grip of said firearm to actuate said locking module and to activate said camera module at the same time when said hand grip is touched.

3. The firearm system, as recited in claim 1, wherein said activation module comprises an environmental activation sensor provided at said firearm to actuate said locking module and to activate said camera module at the same time, wherein said environmental sensor is selected from a group consisting of a light activation sensor and a thermal activation sensor.

4. The firearm system, as recited in claim 1, wherein said activation module comprises a gyro sensor built-in with said firearm to actuate said locking module and to activate said camera module at the same time when a movement of said firearm is detected by said gyro sensor.

5. The firearm system, as recited in claim 1, wherein said camera module comprises a front image capturing unit provided at said firearm for capturing a shooting image of said firearm as one of said user operation data and a rear image capturing unit provided at said firearm for capturing a facial image of a user as one of said user operation data.

6. The firearm system, as recited in claim 5, wherein at least one of said front image capturing unit and said rear image capturing unit further built-in with a voice recorder being activated at the same time for sound recording as one of said user operation data.

7. The firearm system, as recited in claim 5, wherein at least one of said front image capturing unit and said rear image capturing unit comprises a dual camera module which comprises an infrared camera and a camera.

8. The firearm system, as recited in claim 1, wherein said user identification system further comprises a GPS module built-in with said firearm to detect a location of said firearm as one of said user operation data.

9. The firearm system, as recited in claim 1, wherein said activation module further comprises a biometric authentication module built-in with said firearm to unlock said trigger-actuated firing mechanism in response to a biometric information of the user, wherein said biometric authentication module comprises a sensor selected from a group consisting of a fingerprint sensor, an iris recognition sensor, a facial recognition sensor, and a vein recognition sensor.

10. The firearm system, as recited in claim 1, further comprising a user identification server pre-storing said authorized user data therein, wherein said activation module comprises a data transceiver built-in with said firearm to wirelessly and continuously send out said user operation data to said user identification server.

11. The firearm system, as recited in claim 10, wherein said user identification server sends out an unlocking code to said data transceiver to actuate said locking module so as to unlock said trigger-actuated firing mechanism when said user operation data is matched with said authorized user data.

12. The firearm system, as recited in claim 11, wherein said authorized user data comprises said image captured by said camera module and said user operation data of said firearm from said activation module.

13. The firearm system, as recited in claim 1, wherein said locking module is actuated to lock up said trigger-actuated firing mechanism after each shooting operation of said firearm.

14. The firearm system, as recited in claim 1, wherein said user identification system further comprises a power source provided at said firearm for as a single power supply for said locking module, said camera module and said activation module.

15. A method of preventing an unauthorized operation of a firearm, comprising the steps of:
(a) via a locking module built-in with said firearm, normally locking up a trigger-actuated firing mechanism of said firearm from being actuated;
(b) when a user intends to operate said firearm, via an activation module built-in with said firearm, activating said locking module and a camera module for generating tangible evidence of operation incidents;
(c) via said activation module, continuously collecting user operation data of said firearm; and
(d) determining whether a pre-stored authorized user data is matched with said user operation data in order to unlock said trigger-actuated firing mechanism.

16. The method as recited in claim 15 wherein, in the step (b), said locking module and said camera module are activated at the same time via a touch sensor provided at a hand grip of said firearm when said hand grip is touched.

17. The method as recited in claim 15 wherein, in the step (b), said locking module and said camera module are activated at the same time via a gyro sensor built-in with said firearm when a movement of said firearm is detected by said gyro sensor.

18. The method as recited in claim 15 wherein, in the step (c), said user operation data is collected by an environmental sensor selected from a group consisting of a light sensor and a temperature sensor provided at said firearm.

19. The method as recited in claim 15 wherein, in the step (c), said user operation data is collected by a GPS module built-in with said firearm to detect a location of said firearm.

20. The method, as recited in claim 15, wherein the step (b) further comprises a step of capturing a shooting image of said firearm via a front image capturing unit and capturing a facial image of the user via a rear image capturing unit at the same time.

21. The method as recited in claim 15 wherein, in the step (c), said user operation data is collected by a biometric authentication module built-in with said firearm to unlock said trigger-actuated firing mechanism in response to a biometric information of the user, wherein said biometric authentication module comprises a sensor selected from a group consisting of a fingerprint sensor, an iris recognition sensor, and a facial recognition sensor.

22. The method as recited in claim 15 wherein, in the step (c), said trigger-actuated firing mechanism is re-locked by said locking module after each shooting operation of said firearm.

23. The method as recited in claim 15 wherein said locking module, said camera module and said activation module are electrically linked to a power source provided at said firearm as a single power supply.

24. The method, as recited in claim 15, further comprising the steps of:
(e) pre-storing said authorized user data in a user identification server;
(f) via a data transceiver built-in with said firearm, wirelessly and continuously sending out said user operation data to said user identification server; and
(g) sending out an unlocking code from said user identification server to said data transceiver to actuate said locking module so as to unlock said trigger-actuated firing mechanism when said authorized user data is matched with said user operation data.

25. The method, as recited in claim 24, further comprising the steps of:
(h) instantaneously locking said trigger-actuated firing mechanism of said firearm once said user operation data is mismatched with said authorized user data; and
(i) automatically reporting said user operation data to a police station.

26. The method, as recited in claim 24, further comprising the steps of:
(h) instantaneously locking said trigger-actuated firing mechanism of said firearm when a bullet shooting number of said firearm reaches a predetermined bullet shooting threshold; and
(i) automatically reporting said user operation data to a police station.

27. The method, as recited in claim 24, further comprising the steps of:
(h) instantaneously locking said trigger-actuated firing mechanism of said firearm when a user image captured by said camera module matches with criminal data in a criminal record database; and
(i) automatically reporting said user operation data to a police station.
